(19) United States
(12) Patent Application Publication
(10) Pub. No.: US 2008/0270303 A1
(43) Pub. Date: Oct. 30, 2008

(54) Method and system for detecting fraud in financial transactions

(76) Inventors: Janice Zhou, Midland, GA (US); Jane Hua He, Midland, GA (US); Aruna Shankar, Midland, GA (US); Tim Edgar, Pine Mountain, GA (US); Zhonghua Zhou, Midland, GA (US)

Correspondence Address: KING & SPALDING LLP, 1180 PEACHTREE STREET, ATLANTA, GA, 30309-3521, US

(21) Appl. No.: 12/150,378

(22) Filed: Apr. 28, 2008

Related U.S. Application Data
(60) Provisional application No. 60/926,556, filed on Apr. 27, 2007.

(51) Int. Cl. G06Q 40/00

(52) U.S. Cl. 705/44

(57) ABSTRACT

Detecting fraud in financial transactions. The systems and methods manage a fraud detection alert in a fraud queue; automatically locate the associated financial account data; display workflows on a graphical user interface; automatically navigate through workflows; ensure compliance with predetermined rules specific to a account-provider, business, or regulation; store all activity and data related to each fraud detection alert; and automatically update the fraud queue. The systems and methods include a fraud analyst workstation, a workflow engine, a host computer system, and a workflow database. The fraud analyst workstation communicates with the workflow engine, which stores and applies the predetermined rules. The workflow engine communicates with the host computer system to access the financial account data. The workflow engine communicates with a workflow database, which stores all activity and data related to each fraud detection alert for purposes of tracking, billing, and research.

### STATEMENT OF RELATED PATENT APPLICATIONS

This non-provisional patent application claims priority under 35 U.S.C. § 119 to U.S. Provisional Patent Application No. 60/926,556, titled Method and System for Detecting Fraud in Financial Transactions, filed Apr. 27, 2007. This provisional application is hereby fully incorporated herein by reference.

### FIELD OF THE INVENTION

This invention relates to systems and methods for detecting fraud in financial transactions. More particularly, this invention relates to processes and systems that allow fraud analysts or other users to more efficiently access customer data to manage potentially fraudulent financial transactions.

### BACKGROUND OF THE INVENTION

The use of financial cards for conducting financial transactions is ubiquitous. Typically, a credit card represents a line of credit that has been issued from a financial institution, the account provider, to an individual, the account holder. The credit card allows the account holder to purchase goods and services against the line of credit. The line of credit is associated with an account and that account has certain terms governing how credit is extended to the account holder. Typical terms include an annual interest rate charged on the amount of money actually lent to the account holder, a grace period that allows the account holder to pay for purchases without incurring interest charges, annual fees for the account, and other fees, such a late payment fees. Credit cards may be issued by national card associations, such as AMERICAN EXPRESS or DISCOVER CARD; a financial institution in conjunction with a national card association, such as a Bank of America VISA or MASTERCARD; or directly from a retailer, such as MACY'S or BRITISH PETROLEUM.

In addition to credit cards, debit cards allow an account holder to withdraw funds directly from their bank account. Accordingly, purchases are not made on credit, but with funds in an account linked to the particular debit card. Generally, debit cards are issued by financial institutions.

Prepaid cards provide another method to make purchases. A prepaid card has access to a predetermined amount of funds. The predetermined amount is paid in advance of using the card. Each time it is used, the purchase amount is deducted from the prepaid amount.

Credit cards, debit cards, and prepaid cards are used by account holders to make purchases at a variety of institutions. Systems exist to monitor an account's activity to identify fraud. Such systems use logic and algorithms to generate a list of accounts that may have undergone fraudulent activity. In addition, account holders can identify potentially fraudulent activity, by, for example, alerting the issuing entity of suspicious charges. Each account that is identified as having undergone potentially fraudulent activity is typically managed by a fraud analyst.

In conventional systems, a fraud analyst is provided with a list of such accounts that may have undergone fraudulent activity. An account that has undergone potentially fraudulent activity will be referred to herein as a “fraud detection alert.” To manage each fraud detection alert, the fraud analyst accesses a host computer system to locate the particular account. In conventional systems, the host computer system is a mainframe computer. Once logged in to the host computer system, the fraud analyst manually navigates through the mainframe computer to research and manage the account. For example, the fraud analyst can attempt to locate previous charges made on the account.

In addressing such fraud detection alerts, the fraud analyst first accesses the account holder's financial account information. In the conventional system, the fraud analyst accesses data stored among multiple systems or regions. The fraud analyst does this manually, directly accessing the mainframe and viewing the information on a mainframe screen. In addressing the fraud detection alert, the fraud analyst again manually navigates through the mainframe screens to view information. The fraud analyst is not prompted to perform any particular step, nor to view any particular data. Fraud analysts can thus spend an inordinate amount of time researching the fraud detection alert on the mainframe system. Further, the fraud analyst is not provided with a straightforward user interface with applicable menu selections. As such, because of the manual nature of the process, a fraud analyst can sometimes overlook a necessary step in the fraud detection process. In addition, conventional systems do not provide fraud analysts with ready access to or automatic implementation of business or compliance rules, that is, rules instituted by the account provider, or provided for in regulations that govern how potentially fraudulent activity is to be investigated. Accordingly, fraud analysts can frequently violate a business or compliance rule that applies to the account. Finally, the conventional system does not store the fraud analyst's activities. As such, conventional methods do not allow for tracking the management of a fraud detection alert for future reference.

The typical process for managing fraud detection alerts is thus an inefficient, time-consuming, and potentially error-ridden process. In addition, the fraud analyst's activity can not be adequately tracked for purposes of billing, research, and analysis. The conventional process also leads to violation of business or compliance rules, as the rules are not readily available and fraud analysts must perform them manually. Accordingly, a need exists for systems and methods that streamline the process of managing fraud detection alerts to ensure compliance with applicable rules, thus improving fraud detection handling, providing greater efficiencies, fewer mistakes, and tracking capability.

### SUMMARY OF THE INVENTION

The present invention supports systems and methods for detecting fraud in financial transactions to ensure compliance with account-provider, business, and regulatory rules. The systems and methods automate the process of identifying a financial account associated with a fraud detection alert among multiple systems and regions. The term “fraud detection alert” is used herein to describe an account that has been identified as having undergone potentially fraudulent activity. In addition, the systems and methods provide automatic display of available workflows and ensure compliance with the account-provider, business, and regulatory rules when workflows are performed. “Workflows” as used herein refer to actions taken in response to a fraud detection alert, and may include: accessing data associated with a financial account, manipulating data associated with the financial account, performing an activity in relation to the financial account, placing an outbound communication to an account holder, and/or linking to another workflow. For example, workflows can include “add/remove watch,” “complete FFR (found fraud report),” and “order card.” The workflows described herein are complete sets of “instructions” provided to the fraud analyst through a graphical user interface that provide the fraud analyst with the necessary data, forms, and questions to effectively manage the fraud detection alert without subtracting steps or violating a business or compliance rule. In other words, the workflows provide automatic navigation among their various steps, automatically displaying screens and prompting the fraud analyst to address certain issues. The systems and methods may also provide the ability to track and store activity performed in response to fraud detection alert.

In one aspect of the invention, the system includes a fraud analyst workstation and provides for fraud detection in financial transactions. In this aspect of the invention, the system is operable to: access fraud queues, each of the fraud queues including fraud detection alerts; identify a financial account associated with each of the fraud detection alerts; automatically identify a location of data associated with the financial account among systems and regions; display workflows corresponding to the financial account on a graphical user interface; perform workflows in accordance with the one or more predetermined rules; provide automatic navigation within the workflows; automatically update the fraud queue; and store data related to the fraud detection alert in a workflow database.

Another aspect of the invention provides a method for detecting fraud in financial transactions, including the steps of: (a) accessing a fraud queue including fraud detection alerts; (b) selecting a fraud detection alert; (c) retrieving a financial account associated with each of the one or more fraud detection alerts; (d) accessing to data associated with the financial account; (e) displaying data associated with the financial account and workflows on a graphical user interface; (f) in response to determining that the appropriate workflow complies with the predetermined rules, performing the appropriate workflow on the financial account in accordance with the predetermined rules; (g) storing the appropriate workflows performed on the financial account in a workflow database; and (h) automatically updating the fraud queue.

Yet another aspect of the invention provides a system for fraud detection in financial transactions. The system includes a fraud analyst workstation, which includes a fraud detection module, and is operable to access a fraud detection alert; display a graphical user interface including one or more workflow options. A workflow engine is logically connected to the fraud analyst workstation and is operable to automatically identify a location of financial account data associated with the fraud detection alert within a host computer system; store workflows based on predetermined rules; ensure compliance with the predetermined rules during performance of the workflows; automatically navigate through the workflows; and update a fraud queue. The host computer system is logically connected to the workflow engine and includes financial account data for one or more financial accounts. The system also includes a workflow database that is logically connected to the workflow engine and operable to store data associated with the fraud detection alert.

### BRIEF DESCRIPTION OF THE DRAWINGS

FIG. 1 depicts a system architecture in accordance with an exemplary embodiment of the present invention.

FIG. 2 depicts a system architecture in accordance with an exemplary embodiment of the present invention.

FIG. 3 depicts an overall process flow diagram for detecting fraud in financial transactions in accordance with an exemplary embodiment of the present invention.

FIG. 4 depicts a detailed process flow diagram for detecting fraud in financial transactions in accordance with an exemplary embodiment of the present invention.

### DETAILED DESCRIPTION OF THE EXEMPLARY EMBODIMENTS

Exemplary embodiments of the present invention are provided. These embodiments include systems and methods that provide for the seamless detection of fraud in financial transactions. The systems and methods include the ability to manage a fraud detection alert in a fraud queue; automatically locate the associated financial account data; display appropriate workflows on a graphical user interface; automatically navigate through workflows; ensure compliance with certain predetermined rules specific to a account-provider, business, or regulation; store activity and data related to each fraud detection alert; and automatically update the fraud queue. The systems and methods include a fraud analyst workstation, a workflow engine, a host computer system, and a workflow database. The fraud analyst workstation communicates with the workflow engine, which stores and applies the predetermined rules. The workflow engine communicates with the host computer system to access the financial account data. The workflow engine also communicates with a workflow database, which stores all activity and data related to each fraud detection alert for purposes of tracking, billing, statistics, and research.

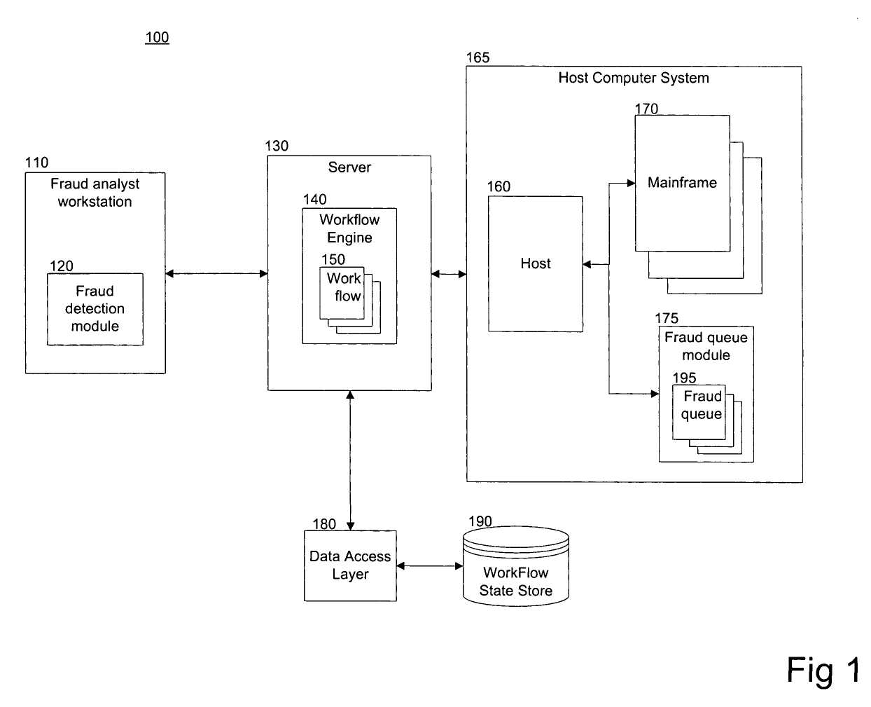

FIG. 1 depicts a system architecture 100 in accordance with an exemplary embodiment of the present invention. Referring to FIG. 1, the system architecture 100 includes a fraud analyst workstation 110. In this exemplary embodiment, a fraud analyst is a representative of a financial account processor responsible for managing fraud detection alerts. The fraud analyst workstation 110 may be part of a local area network (LAN), wide area network, including the Internet, or a part of both types of networks. The fraud analyst workstation 110 may be connected to one or more computers (not shown) that control the programming and operation of the fraud analyst workstation 110. In this exemplary embodiment, the fraud analyst workstation 110 is used by a fraud analyst to process and manage fraud detection alerts. Each fraud detection alert represents a financial account in which potential fraud has been identified.

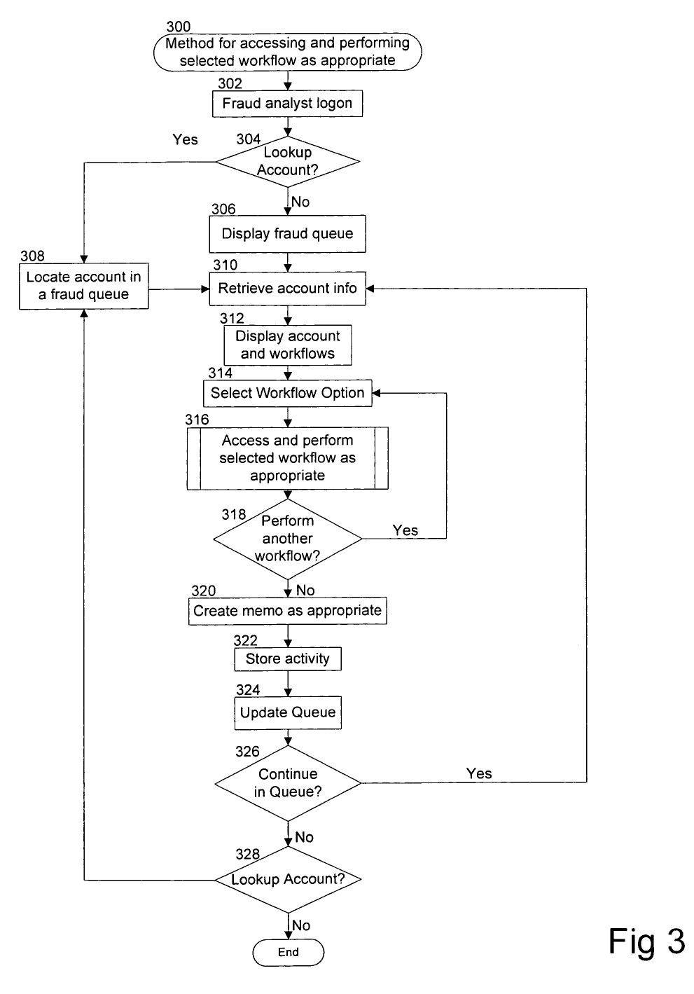

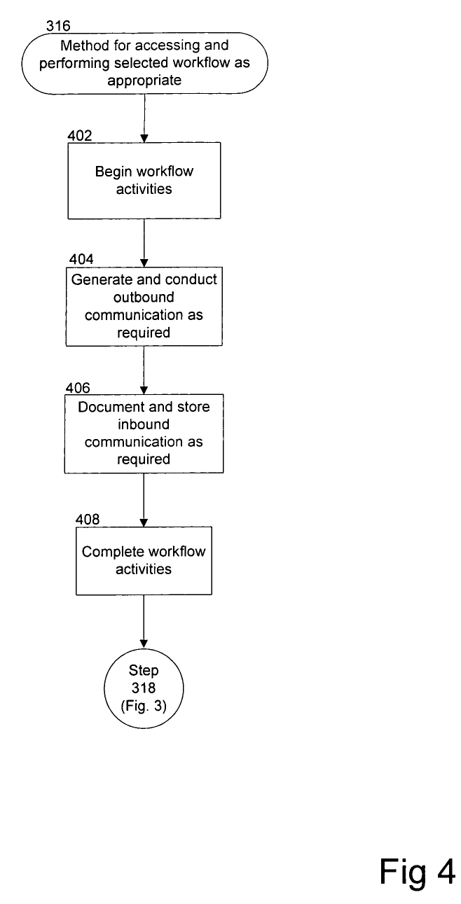

The fraud analyst workstation 110 includes a fraud detection module 120. The fraud detection module 120 is an application that provides a graphical user interface (GUI) and operates on the fraud analyst workstation 110. The fraud detection module 120 allows the representative using the fraud analyst workstation 110 to efficiently access account holder data and perform workflows to manage the fraud detection alerts. The workflows and GUI will be described in more detail herein with reference to FIGS. 3-4.

The fraud analyst workstation 110 communicates with a server 130. The server 130 includes a workflow engine 140. The workflow engine 140 is an application that stores and runs the workflows 150 that can be accessed to manage the fraud detection alerts.

The workflows 150 represent particular parts of the fraud management process. Workflows 150 include one or more coded steps in a fraud management process. These steps may include receiving data from the GUI, retrieving data, generating reports or information, and presenting information on the GUI. Each workflow 150 is designed based on rules specific to a business, regulation, and/or account-provider. Such rules are requirements and instructions that govern how a fraud detection alert is handled and are provided for by a particular account provider, internal business policy, or regulation. The workflows 150 thus provide automatic navigation through the steps, while ensuring compliance with such rules and, in addition, preventing violation of such rules.

The workflow engine 140 provides the ability to operate various workflows 150, which apply the relevant business or regulatory rules, to efficiently and effectively manage the fraud detection alert. Particular workflows 150 will be described in more detail herein below with reference to FIG. 4. When certain workflows 150 are applied, the workflow engine 140 can initiate access to the host computer system 165 to automatically access the relevant account holder data. As such, the fraud analyst need not separately log in to the host computer system 165, as this step is performed by the workflow engine 140. An administrator can access the workflow engine 140 to add, delete, or change the business or compliance rules and/or the workflows 150. Generally speaking, business or compliance rules are requirements that govern how a fraud detection alert is to be managed, and are instituted by the account-provider, provided for in regulations related to managing potentially fraudulent activity, or designated internally by a financial account processor.

In this exemplary embodiment, the host computer system 165 includes a host 160. The host 160 is a large data processing system and can store and access information related to the consumer's account. The host 160 can be a network server, web server, a mainframe computer, or another suitable host computer. The host 160 can access mainframes 170, where account information can be stored. When the host computer system 165 is accessed by the server 130, the host 160 locates the requested data among the mainframes 170. In other words, when the server 130 accesses the host computer system 165, the host 160 is activated to locate the requested data among the mainframes 170. Account holder data is stored among the mainframes 170 based on account-provider. Such data includes account holder information; account history; recent charges; and other data related to the account. Additionally, because the server 130 communicates with the fraud analyst workstation 110 and the host computer system 165, data obtained from the mainframes 170 can be displayed on the GUI of the workstation 110.

The host computer system 165 also includes a fraud queue module 175. The fraud queue module 175 includes fraud queues 195, that each contain one or more fraud detection alerts. The fraud queues 195 may be populated by an automated system that is operable to track, monitor, and flag account activity for potentially fraudulent activity. In addition, a fraud analyst or other representative of the account processor, in response to a call or other inquiry from the account holder, can populate the fraud queues 195. In an alternative embodiment, a separate system designed to manage risk related inquiries from account holders can populate the fraud queues 195. In this alternative embodiment, investigation of a risk related inquiry can lead to the discovery of potentially fraudulent activity, and, in turn, automatically create a fraud detection alert for population in the fraud queues 195.

Each fraud queue 195 contains fraud detection alerts for a single account-provider. “Account-provider” is used herein to refer to the account issuing entity, such as the national card association or financial institution. For example, a fraud queue 195 can contain only fraud detection alerts for a certain credit card association, such as VISA. In an alternative embodiment, a fraud queue 195 can contain fraud detection alerts of a certain risk level, from various account-providers. A risk-level can be determined based on how likely fraudulent activity is to have occurred, and/or the frequency of potentially fraudulent activity on a particular account. In yet another alternative embodiment, a fraud queue 195 can contain fraud detection alerts based on other attributes, such as, for example, the account holder information and/or the amount of a potentially fraudulent charge. The systems and methods described herein are operable will all varieties of fraud queues 195.

The server 130 can also communicate with a data access layer 180. The data access layer 180 captures the activity of the workflow engine 140. Activity of the workflow engine 140 includes the workflows performed, business or regulatory rules applied, and data accessed through host 160. In other words, the data access layer 180 can capture the inquiries made and actions performed on the account in relation to each fraud detection alert accessed by a fraud analyst. In addition, the data access layer 180 can capture other attributes of the management of a fraud detection alert. For example, the data access layer 180 can capture the amount of time spent on the fraud detection alert.

The data access layer 180 communicates with the workflow state store 190. The workflow state store 190 is a database used to store the activity captured by the data access layer 180. The workflow state store 190 stores such data for purposes of billing, tracking, and research as it pertains to fraud detection. An administrator can access the workflow state store 190 for such purposes.

The system architecture 100 thus allows for the retrieval of information stored on mainframes 170 without requiring the fraud analyst to directly access the host 160 to navigate among the mainframes 170. In addition, the information retrieved is displayed on the fraud analyst workstation 110 through a GUI provided by the fraud detection module 120.

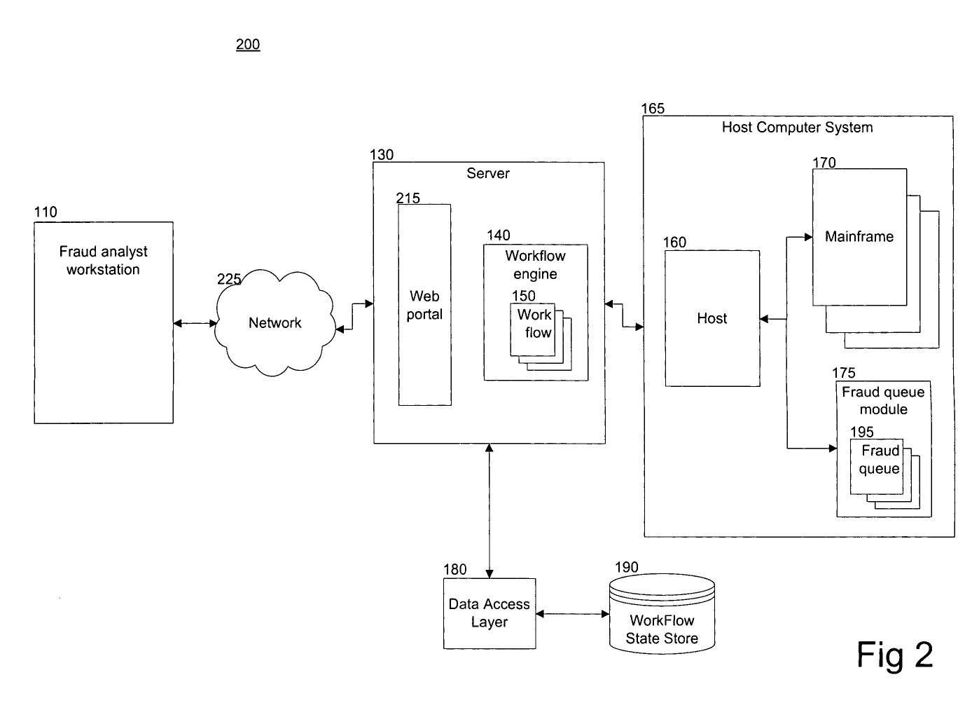

FIG. 2 depicts a system architecture 200 in accordance with an exemplary embodiment of the present invention. FIG. 2 is largely the same as FIG. 1, and the differences will be described herein with reference to FIG. 1. In FIG. 2, the server 130 includes a web portal 215. The web portal 215 provides access to the functionality of the server. The network 225 can be the Internet, a dedicated communication line, shared network switch or other suitable network. As shown in FIG. 2, the fraud analyst workstation 110 can communicate by way of the network 225 with the server 130 using the web portal 215. In this embodiment, the workstation 110 need not include a fraud detection module 120 because the workstation 110 is capable of accessing the application in a different location by using a thin client application, such as a web browser. Accordingly, the fraud detection module 120 can be located on the server 130, or in another location accessible via the network (not shown).

FIG. 3 depicts an overall process flow diagram 300 for detecting fraud in financial transactions in accordance with an exemplary embodiment of the present invention. Referring to FIG. 1, a process for detecting fraud in financial transactions can be described. FIG. 4, discussed in detail below, provides additional details on this overall process.

At step 302, a representative, such as a fraud analyst, logs on to the fraud analyst workstation 110. In particular, the fraud analyst accesses the fraud detection module 120 on the fraud analyst workstation 110. The fraud detection module 120 provides the fraud analyst with a GUI login screen. The fraud analyst uses an assigned login identification and password to logon to the fraud analyst workstation 110. In general, all activity performed by a fraud analyst in relation to the financial account is conducted using the GUI displayed on the fraud analyst workstation 110.

At step 304, the fraud analyst determines whether to look up a particular account. In an exemplary embodiment, the fraud analyst will look up a particular account in response to the receipt of a telephone call regarding an account associated with a fraud detection alert. If, at step 304, the determination is made to look up an account, the method proceeds to step 308, and the method proceeds as described herein below. If, at step 304, the determination is made not to look up an account, the method proceeds to step 306.

At step 306, the fraud detection module 120 displays a fraud queue 195 on the GUI of the fraud analyst workstation 110. At this step, the workflow engine 140 communicates with the host computer system 165 to retrieve a fraud queue 195. The fraud analyst first selects which account-provider's fraud queue 195 from which to work. In an alternative embodiment, the fraud analyst can designate another type of fraud queue 195 from which to work, or the workflow engine 140 can automatically assign a fraud queue 195. The fraud queue 195 is displayed on the GUI on the fraud analyst workstation 110. The method proceeds to step 310, described herein below.

At step 308, the workflow engine 140 locates the financial account associated with a positive determination to look up an account at step 304. At this step, the fraud detection module 120 locates the account among the fraud queues 195. In another exemplary embodiment, the fraud analyst can search for the account holder's account by searching by bank or account-provider.

At step 310, the workflow engine 140 retrieves the account information associated with the fraud detection alert. If the GUI displayed a fraud queue 195 at step 306, the workflow engine 140 automatically selects a fraud detection alert from the fraud queue 195. In an alternative embodiment, the fraud analyst can select a particular fraud detection alert from the fraud queue 195 using the GUI displayed on the fraud analyst workstation 110. The fraud analyst workstation 110 communicates with the workflow engine 140 on the server 130. The workflow engine 140 initiates access with the host computer system 165 to retrieve information regarding the account information entered at step 308 or from the fraud queue 195 displayed at step 306. Accordingly, the fraud analyst need not directly interface with the host computer system 165.

At step 312, the GUI on the fraud analyst workstation 110 displays the account information and workflows 150. The workflows 150 are displayed as menu options on the GUI. In this exemplary embodiment, the GUI displayed at step 312 includes menu options that lead to workflows 150. The workflow engine 140 customizes the menu options displayed on the GUI by fraud analyst, account, and/or account-provider. Accordingly, the list of optional workflows displayed at step 312 may include greater than or fewer than those listed here, depending on the fraud analyst, the account, and/or the account-provider.

At step 314, the fraud analyst selects a workflow 150 from the menu options displayed at step 312 by clicking on the GUI. The workflows 150 will be described herein with reference to FIG. 4.

At step 316, the workflow 150 selected at step 314 is accessed and performed as appropriate. Step 316 is described in more detail herein below with reference to FIG. 4.

At step 318, the fraud analyst or the workflow engine 140 determines whether another workflow is to be performed with regard to the financial account associated with the fraud detection alert. The workflow engine 140, in response to completion of a particular workflow, can prompt the fraud analyst to perform an additional workflow 150. Each workflow 150 includes a sequence of steps, displayed among one or more screens, to ensure that the workflow is completed efficiently and accurately. Accordingly, the workflow engine automates the navigation of workflows 150 for the fraud analyst. In addition, an fraud analyst can manually select an additional workflow 150, based on the fraud detection alert. If another workflow is to be performed, the method proceeds to step 314, and the method proceeds as described previously herein. If another workflow is not to be performed, then the method proceeds to step 320.

At step 320, the fraud analyst can create a memo to document the fraud detection alert that the fraud analyst managed at steps 310-316. For example, the fraud analyst can manually type notes into the memo indicating particular details related to the account, the account holder, the issues, and/or the action taken on the account. The memo created at step 320 provides documentation for future reference.

At step 322, the activity of a fraud analyst taken on the fraud analyst workstation 110 at steps 302-320 is stored in the workflow data store 190. More particularly, the data access layer 180 continuously captures the activity performed, as it relates to each fraud detection alert, by communicating with the server 130. The workflow state store 190 stores this data as described herein with reference to FIG. 1. The activity captured by the data access layer 180 and stored by the workflow state store includes: the particular queues 195 that were selected and managed; the particular fraud detection alerts within each fraud queue 195 that were selected and managed; the particular workflow(s) that were selected, accessed, or performed; memos created at step 320; and documentation of any outbound communication with the account holder. The data access layer 180 also captures data related to the fraud detection alert including: the account number; duration of management of each fraud detection alert; memos made at step 318; and other measures related to fraud detection. An administrator can access the workflow state store 190 to efficiently obtain information related to each fraud queue 195 and/or fraud detection alert, for purposes of billing a account-provider, tracking fraud analyst efficiency, and for statistical and research purposes.

At step 324, the workflow engine 140 updates the fraud queue 195 to reflect any changes based on the activities taken at steps 302-322. For example, if the fraud detection alert is taken out of the fraud queue 195 during performance of a workflow 150, the fraud queue would reflect the change. As another example, if a “watch” is put on the account associated with the fraud detection alert, the status of the fraud detection alert would update accordingly in the fraud queue 195 at step 324.

At step 326, the fraud analyst determines whether to continue processing fraud detection alerts in the fraud queue 195 entered at step 306. If the determination is made to continue in this fraud queue 195, the method proceeds to step 310, and the method proceeds as described previously herein. By continuing in the fraud queue at step 326, the fraud detection module 120 automatically displays the next fraud detection alert, from the fraud detection queue 195, on the GUI screen on the fraud analyst workstation 110. In this way, the fraud analyst can seamlessly manage fraud detection alerts from account-providers, by having the relevant data automatically populated to a uniform GUI display. The fraud analyst need not log into the system again to process additional fraud detection alerts, whether they are from the same or different account-providers as the previous fraud detection alert. If the determination is made to not continue in the queue, the method proceeds to step 328.

At step 328, the fraud analyst determines whether to look up a particular account. Step 328 is similar to step 304, as described previously herein. If, at step 328, the determination is made to look up an account, the method proceeds to step 308, and the method proceeds as described previously herein. If, at step 328, the determination is made not to look up an account, the method ends.

FIG. 4 depicts a detailed process flow diagram for detecting fraud in financial transactions in accordance with an exemplary embodiment of the present invention. The method will be described herein with reference to FIGS. 1-3.

At step 402, the workflow engine begins performance of the workflow 150 selected at step 316 of FIG. 3. The workflow engine 140 begins performance by accessing the appropriate workflow 150. Each workflow 150 embodies account-provider, business, and regulatory specific rules. Accordingly, when the particular workflow is selected and performed, the workflow is carried out in a manner that is compliant with these rules. For example, a particular account-provider may prohibit certain workflows from being performed on their account holders' accounts. or require that they are performed in a certain manner. As an example, VISA may prohibit a financial account from being blocked outside the United States in response to a report of a lost card.

The step of beginning performance of a workflow also includes displaying screens associated with the workflow 150 on the GUI. The screen may take on a variety of formats. For example, the screens can display information about the account, such as potentially fraudulent charges; menu options; and/or forms. Aspects of a workflow 150 can be displayed on a single screen, multiple screens, or be embodied in the current display of the fraud analyst workstation 110. Certain workflows include multiple steps, and thus require the fraud analyst to proceed through all the necessary steps of each workflow. For example, for the fraud detection workflow for “review post tran, trends, notes,” the workflow provides data on the GUI displaying the current transaction, and allows the fraud analyst to selet an option to view previous transactions. From the “previous transaction” screen, the fraud analyst can select an option to view the “trends” screen. From the “trends” screen, the fraud analyst can select an option to “view events detail.” In other words, the workflows provide automatic navigation among the various steps, thus ensuring that a fraud analyst cannot overlook a particular step. Accordingly, the workflows 150 can essentially walk the fraud analyst through screens, wherein the coding behind the screens can efficiently provide the relevant information and perform the requisite activities to ensure effective completion of the fraud detection alert management process. Further, multiple workflows 150 can be performed in sequence, and one workflow can automatically link to another workflow. As such, workflows may be performed in varying sequences to ensure that the fraud detection alerts are handled most efficiently. For example, after an agent completes a workflow for a “lost/stolen report,” the workflow engine 140 prompts the agent to “order card.” As such, workflows may be performed in varying sequences to ensure that the fraud detection alert is handled most efficiently. The workflow engine thus streamlines the approach to managing fraud detection alerts.

The data necessary to perform any of the workflows 150 are obtained when the workflow engine 140 initiates access to the host computer system 165, which locates the data among the mainframes 170. In turn, the data is displayed on the GUI on the fraud analyst workstation 110.

At step 404, the fraud analyst, through the fraud analyst workstation 110, generates and conducts any outbound communications as required by the workflow 150. Outbound communications may include letters, telephone calls, emails, and/or another type of communication. An outbound communication can include a telephone call or a letter. In an alternative embodiment, an outbound communication can include an electronic message, a text message, and/or an instant message. In an exemplary embodiment, the fraud analyst places the outbound communication, such as a telephone call.

At step 406, the fraud analyst, through the fraud analyst workstation 110, documents and stores any inbound communications received, as required by the workflow 150. Inbound communications may include letters from account holders and/or sales drafts from merchants. The fraud analyst can document the receipt of such communications, as well as other details regarding the communication. The workflow engine 150 provides the requisite navigation and prompting of the fraud analyst to ensure that inbound communications are properly stored and documented.

At step 408, the workflow is completed. As described above with reference to step 402 of FIG. 4, the workflows can include a sequence of steps and display information using multiple screens. Completion of the workflow at step 408 simply means to perform any remaining steps of a the workflow selected at step 314 of FIG. 3.

The workflow engine 140 thus streamlines the approach to managing fraud detection alerts. Provided herein are just a few examples of the many available types and configuration of workflows, and other workflows and workflow configurations can be made without departing from the spirit and scope of the invention.

One of ordinary skill in the art would appreciate that the present invention supports systems and methods for detecting fraud in financial transactions. The systems and methods may include the ability to access fraud detection alerts through a variety of platforms, including electronic mail, formatted file, or directly from a financial account processing system. The systems and methods interact with a host computer system and a server to manage the fraud detection alert.

Although specific embodiments of the present invention have been described above in detail, the description is merely for purposes of illustration. Modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed:

1. A system for fraud detection in financial transactions comprising a fraud analyst workstation and operable to:
access a fraud queue, the fraud queue comprising a fraud detection alert;
identify a financial account associated with the fraud detection alert;
automatically identify a location of data associated with the financial account among a computer system and a mainframe region;
display a list of workflow options corresponding to the financial account on a graphical user interface;
perform a workflow in accordance with a predetermined rule;
provide automatic navigation through the workflow;
automatically update the fraud queue; and
store data related to the fraud detection alert in a workflow database.

2. The system of claim 1, wherein the fraud queue comprises the fraud detection alert grouped by at least one of an account-provider; a risk level; an amount of a charge; and another type of fraud-related measure.

3. The system of claim 1, wherein the fraud detection alert comprises at least one of an account number, a bank, a credit card association, a name, a social security number, an amount, and another type of account identifier.

4. The system of claim 1, further comprising a workflow engine, operable to store the workflow, wherein the workflow is based the predetermined rule.

5. The system of claim 4, wherein the workflow engine runs the workflow.

6. The system of claim 1, wherein the predetermined rule corresponds to at least one of account-provider-specific, business-specific, and regulatory requirements.

7. The system of claim 1, wherein the workflow comprises steps corresponding to performing an activity in relation to the financial account.

8. The system of claim 7, wherein the workflow automatically navigates through the steps corresponding to performing an activity in relation to the financial account.

9. The system of claim 1, further comprising a data access layer, operable to capture and store in the workflow database, data related to the fraud detection alert, the data related to the fraud detection alert comprising at least one of: the financial account; the workflows performed; the data accessed; and other data related to the fraud detection alert.

10. The system of claim 1, wherein an administrator can access the workflow database for purposes of at least one of: billing, tracking, statistical compilations, and research.

11. A method for detecting fraud in financial transactions, comprising the steps of:
a) accessing a fraud queue comprising a fraud detection alert;
b) selecting the fraud detection alert;
c) retrieving a financial account associated with the fraud detection alert;
d) accessing data associated with the financial account;
e) displaying data associated with the financial account and a list of workflow options on a graphical user interface;
f) performing the workflow on the financial account, the workflow based on a predetermined rule;
g) storing the workflow performed on the financial account in a workflow database; and
h) automatically updating the fraud queue.

12. The method of claim 11, wherein the fraud detection alert comprises at least one of an account number, a bank, a credit card association, a name, a social security number, a fraud type, and another type of account identifier.

13. The method of claim 11, wherein the step of retrieving a financial account associated with the fraud detection alert further comprises accessing a host computer system.

14. The method of claim 13, wherein the host computer system comprises a mainframe computer system.

15. The method of claim 11, wherein the predetermined rule correspond to at least one of account-provider-specific, business-specific, and regulatory requirements.

16. The method of claim 11, wherein the workflow comprises steps that correspond performing an activity related to fraud detection in financial transactions.

17. The method of claim 16, wherein the workflow further comprises automatic navigation through the steps that correspond to performing an activity related to fraud detection in financial transactions

18. The method of claim 11, wherein the step of performing the appropriate workflow on the financial account in accordance with the predetermined rule further comprises preventing performance of the workflow that is not compliant with the predetermined rule.

19. The method of claim 11, wherein an administrator can access the workflow database for purposes of at least one of: billing, tracking, statistical compilations, and research.

20. A system for fraud detection in financial transactions comprising:
a fraud analyst workstation, comprising a fraud detection module operable to:
access a fraud detection alert;
display a graphical user interface comprising a list of workflow options; and
a workflow engine, logically connected to the fraud analyst workstation and operable to:
automatically identify a location of financial account data associated with the fraud detection alert within a host computer system;
store the workflow, wherein the workflow is based on a predetermined rule;
ensure compliance with the predetermined rule during performance of the workflow;
automatically navigate through the workflows; and
update a fraud queue;
the host computer system, logically connected to the workflow engine, comprising financial account data for a financial account and operable to communicate with the workflow engine;
a workflow database, logically connected to the workflow engine and operable to store data associated with the fraud detection alert.

21. The system of claim 20, wherein the predetermined rule comprise rules particular to at least one of: a bank, a credit card association, a regulatory agency, a law, and a business.

22. The system of claim 20, wherein the workflow engine is further operable to prohibit performance of workflows that violate the predetermined rule.

23. The system of claim 20, wherein the workflow comprises steps corresponding to performing an activity related to fraud detection in financial transactions.

24. The system of claim 20, wherein an administrator can access the workflow engine for purposes of adding, deleting, and changing the predetermined rule.

25. The system of claim 20, wherein the host computer system comprises a mainframe computer system.

26. The system of claim 20, wherein the data associated with the fraud detection alert and stored by the workflow database comprises at least one of: the workflows performed in response to the fraud detection alert; the financial account data; the location of the financial account data; and other properties of the fraud detection alert.

27. The system of claim 20, wherein an administrator can access the workflow database for purposes of at least one of: billing, tracking, compiling statistics, and research.
